(19) United States
(12) Patent Application Publication
(10) Pub. No.: US 2021/0115531 A1
(43) Pub. Date: Apr. 22, 2021

(54) Microwave Gun and Arc Plasma Torch Furnace

(71) Applicant: Jin Tong Wang, Brooklyn, NY (US)

(72) Inventor: Jin Tong Wang, Brooklyn, NY (US)

(21) Appl. No.: 16/656,089

(22) Filed: Oct. 17, 2019

(51) Int. Cl. C22B 34/12; C03B 5/02; C22B 4/00; F27D 99/00

(52) U.S. Cl. CPC C22B 34/1295; F27D 99/0006; C22B 4/005; C03B 5/025

(57) ABSTRACT

The invention is a microwave gun and arc plasma torch furnace used to refine titanium, Ti, from titanium dioxide, TiO₂, powder. The furnace includes high frequency microwave emitters that create a high temperature zone strongly vibrating the titanium dioxide powder, TiO₂, and lengthening and weakening the valence bonds in the titanium dioxide powder, TiO₂, titanium, Ti, and oxygen, O, atoms. The furnace also uses nitrogen arc plasma torch generators to generate a N⁺ plasma to completely disassociate the titanium, Ti, and oxygen, O, atoms into titanium ions, Ti⁺ and oxygen ions, O⁻, and permitting the formation of nitrogen dioxide, NO₂, and melted titanium, Ti.

### FIELD OF THE INVENTION

The present invention relates generally to the refining titanium, Ti, from titanium dioxide TiO₂ powder, and more particularly to an article and method for use in the refining process.

### BACKGROUND OF THE INVENTION

Titanium, Ti, is the fourth most abundant structural metal on Earth, exceeded only by aluminum, Al, iron, Fe, and magnesium, Mg. Titanium metal is used as an alloying agent with metals including aluminum, Al, iron, Fe, molybdenum, Mo, aluminum, Al, and manganese, Mn, Alloys of titanium are mainly used in aerospace, aircraft and engines where strong, lightweight, high temperature and collusion-resistant materials are needed. Titanium powder is widely used in coatings, plastics, papermaking, printing ink, chemical fiber, rubber, cosmetics and other industries. Titanium wire can be used in the field of life and biological medicine such as golf ball heads, rackets, artificial joints, surgical instruments and so on.

Titanium, Ti, must undergo a number of processes to get from an ore to a finished product. The number of steps used to process titanium, Ti, depends on the application for which the titanium is intended. The titanium, Ti, used in a high-end car exhaust, hip implant or watch does not require the same rigorous management of microstructure as that used in aviation, where the risks and consequences of failure are considerably greater. Regardless of the final usage, titanium, Ti, must first be removed from its ore and turned into pure titanium.

The conventional method of removing titanium, Ti, from ore is called the Kroll process. The titanium, Ti, is refined by processing titanium oxide, TiO₂, manufactured from either ilmenite or rutile. The Kroll Process is a multi-stage reaction which starts in a fluidized bed reactor. Purified titanium oxide TiO₂ is oxidized with chlorine to create titanium tetrachloride, TiCl₄, known as “tickle”. This reaction is done at 1000° C. The tickle (e.g., TiCl₄) often includes other impurities. The tickle and the other metal chloride impurities are fractionally distilled to produce a pure mixture of titanium tetrachloride, TiCl₄.

The pure mixture of titanium tetrachloride, TiCl₄ is moved into a separate stainless steel reactor where it can be mixed with magnesium, Mg. The mixing of the titanium tetrachloride, TiCl₄, and magnesium, Mg, takes place in an atmosphere of argon, Ar, at a preheated temperature of 1000° C. Titanium (Ill) and Titanium (II) chlorides are produced which slowly reduce to form pure titanium, Ti, and magnesium chloride, MgCl₂, over a number of days.

The leftover magnesium chloride, MgCl₂, is then recycled by separating it back into its constituents. Whilst the titanium, Ti, now in “sponge” form, is jackhammered out, crushed into smaller pieces, and pressed back together to produce a uniform piece. It is ready to be melted as the electrode in, for example, the Vacuum Arc Remelting (VAR) process.

Titanium, Ti, is conventionally sold and processed to make alloys using in titanium ingots. The manufacture of titanium ingots starts by forming the titanium sponge, as noted above, and titanium scrap from the refining process into compacts using a press. The titanium sponge and scrap are joined together by plasma arc welding to make a consumable electrode, which goes through an arc melting in a vacuum or inert atmosphere to become the “first melt ingot.” To ensure even quality, the first melt ingots are used as electrodes and remelted to form the “second melt ingot.” After quality control checks, the second melt ingots produced are shipped as final products.

The conventional method refining titanium, Ti, from titanium dioxide includes multiple steps that use different equipment to get to the end product. This process is very expensive, which heightens the price of articles made of titanium, Ti. What is needed is a process of refining titanium, Ti, from titanium dioxide, TiO₂ that is less expensive because it uses less steps and equipment in refining titanium, Ti, from TiO₂ powder. A suitable process may be able to refine titanium ingots directly from titanium dioxide powder.

### BRIEF SUMMARY OF THE INVENTION

The present invention provides a microwave and arc plasma torch furnace for use in refining titanium, Ti. The method disclosed herein uses the microwave and arc plasma torch furnace to produce titanium, Ti, directly from titanium dioxide, TiO₂ powder. Consequently, the present invention uses fewer steps and equipment to refine TiO₂ powder into titanium, Ti, than is used in conventional titanium, Ti, refining process. Specifically, the present invention refines titanium dioxide, TiO₂, powder into pure titanium, Ti, without the need to oxidize the titanium dioxide, treat the TiO₂ with chlorine, CI, or to produce titanium tetrachloride, TiCl₄ during the refining process. In addition, the present invention eliminates the need to create a “sponge” as required in conventional refining methods.

The invention uses the short frequency microwave emitter (e.g., microwave gun) to create high temperature zone of 1,200° C. The temperature produced in the high temperature zone is much less than the 6000-10,000° C. necessary completely disassociate the titanium atoms, Ti, and the oxygen atoms, O, in titanium dioxide powder, TiO₂. In the 1,200° C. high temperature zone the titanium, Ti, and oxygen atoms in titanium dioxide TiO₂ will not disassociate. Instead, the atoms will strongly vibrate. However, the vibration caused in this high temperature zone is much less than the necessary temperature to completely disassociates the titanium atoms, Ti, and oxygen atoms, O in TiO₂ molecule. To disassociate the titanium, Ti, and oxygen, O, atoms from TiO₂ molecule the temperature is estimated as high as 6000-10,000° C.

However, the temperature in the temperature zone 1200° C. is sufficient to cause the titanium, Ti, and oxygen, O, atoms in the TiO₂ molecule to strongly vibrate. The strong vibration lengthens and weakens the valence bonds in the TiO₂ molecules. The microwave emitters waveguides may be located placed on the cross section of the furnace. But the center lines of the waveguides are 5 mm shift from the radiate lines of the circle. The purpose of this arrangement is to let the microwaves emitted from waveguides can cause the TiO₂ powder in the chamber to rotate, so that the rotating vibrating TiO₂ powder is heated evenly in the high temperature zone.

The invention uses a nitrogen arc plasma torch producing a very high temperature (6,000-10,000° C.) N⁺ jet. The temperature at the center of the plasma torch may be estimated to be about 6,000-10,000° C. The energy generated by the high temperature N⁺ jet is higher than is required to disassociate the titanium and oxygen atoms in the TiO₂ molecule. The disassociation of the TiO₂ molecule produces titanium ions, Ti⁺, and oxygen ions, O⁻.

It is well known that an arc plasma torches works by sending an electric arc through a gas medium that is passing through a constricted opening. The current invention uses an arc plasma torch that passes an electric arc through nitrogen gas to produce free N⁺ ions and e⁻. In accordance with the invention, the free N⁺ ions react with the oxygen ions, O⁻, to produce nitrogen dioxide, NO₂. The titanium ions, Ti⁺, have disassociated from the oxygen ions, O⁻, and will not recombine with them. Therefore, the ions, Ti⁺, will obtain electrons to form melted titanium molecules, Ti. The invention then provides the melted titanium, Ti, from an outlet pipe in the microwave arc plasma torch furnace bottom end. The invention then uses an air pump to expel the nitrogen dioxide, NO₂, from the microwave and arc plasma torch furnace. The invention may then provide the melted titanium, Ti, from an outlet pipe in the microwave arc plasma torch furnace bottom end.

In one particular aspect of the invention, the invention teaches a microwave and arc plasma torch furnace that uses microwave emitters to generate a high temperature zone for including titanium dioxide, TiO₂, therein. The high temperature zone cause TiO₂ to strongly vibrate thereby lengthening the valence bonds between the titanium atoms, Ti, and the oxygen atoms, O, in TiO₂.

In another aspect of the invention, the invention teaches a microwave gun and arc plasma arc torch furnace that uses a very high temperature N⁺ jet to disassociate the lengthened valence bonds between Ti atoms and O atoms in heated TiO₂ molecules to produce titanium ions, Ti⁺, and oxygen ions, O⁻. In this aspect, the invention enables the combing of N⁺ with the oxygen ions O⁻ to produce nitrogen dioxide, NO₂, and the combing of Ti⁺ with electrons e⁻ to produce melted titanium, Ti.

In still another aspect, the invention teaches a method for refining TiO₂ powder into titanium, Ti, which involves heating the titanium dioxide powder, TiO₂ until it strongly vibrates; and subjecting the strongly vibrating powder to high temperature N⁺ jet so that the titanium and oxygen atoms completely disassociate into titanium ions, Ti⁺, ions, and oxygen ions, O⁻. In this aspect, the positively charged nitrogen N+ ions combine with the oxygen ions, O⁻, to produce nitrogen dioxide, NO₂ and melted titanium, Ti, remains.

In one exemplary embodiment, the invention teaches a microwave gun and arc plasma torch furnace for generating melted Ti from TiO₂ powder, having an outer shell, the furnace comprising:
a. A cylindrical shaped upper portion including,
   1. A cylindrical shaped upper portion outer wall,
   2. A cylindrical shaped upper portion inner cavity formed by the inner surface of the cylindrical shaped upper portion outer wall, wherein the cylindrical shaped upper portion inner cavity is parallel to the central axis of cylindrical shaped upper portion, and wherein the cylindrical shaped upper portion inner cavity facilitates a cylindrical shaped upper portion first open end and a cylindrical shaped upper portion second open end,
      wherein the cylindrical shaped upper portion first open end is located on a distal end of the cylindrical shaped upper portion from the cylindrical shaped upper portion second end,
   3. A top cover in coupled to with the cylindrical shaped upper portion first open end,
   4. An inlet pipe coupled to the top cover for providing access to the cylindrical shaped upper portion inner cavity, wherein the inlet pipe facilitates titanium dioxide powder to be included into the cylindrical shaped upper portion inner cavity,
   5. A plurality of microwave emitters coupled to the cylindrical shaped upper portion outer wall for directing high frequency microwave radiation into the cylindrical shaped upper portion inner cavity to produce a high temperature zone for lengthening and weakening the valence bonds between the titanium atom, Ti, and the oxygen atoms, O, in the titanium dioxide, TiO₂, wherein the location of the plurality of microwave emitters are predetermined to facilitate rotation and even heating of the TiO₂ powder, and wherein the cylindrical shaped upper portion inner cavity is configured to provide the heated and rotated TiO₂ powder to the cylindrical shaped upper portion second open end,
b. A funnel shaped lower portion having a first open end coupled to the cylindrical shaped upper portion second open end, the funnel shaped lower portion further including,
   1. A funnel shaped lower portion outer wall,
   2. A funnel shaped lower portion inner cavity formed within the funnel shaped lower portion outer wall for receiving the heated and rotated TiO₂ powder, wherein the inner cavity facilitates a funnel shaped lower portion first open end and a funnel shaped lower portion second open end, wherein the funnel shaped lower portion inner cavity is conical in shape, wherein the funnel shaped lower portion outer wall includes an inner surface configured to facilitate a liquid being transported from the funnel shaped lower portion first open end to funnel shaped lower portion second open end, wherein the second open end of the cylindrical shaped upper portion is in communication with the first open end of the funnel shaped lower portion, wherein the cylindrical shaped upper portion inner cavity and the funnel shaped lower portion inner cavity form a funnel cavity,
   3. An arc plasma torch generator coupled to the funnel shaped lower portion outer wall, wherein the arc plasma torch generator generates nitrogen, N⁺ jet, torch into the funnel shaped lower portion inner cavity, and wherein the arc plasma torch generator directs the N⁺ jet torch toward funnel shaped portion second open end, wherein the arch plasma torch disassociates the titanium atom, Ti, and the oxygen atoms, O, in the TiO₂ molecules to produce nitrogen dioxide, NO₂, and melted titanium, Ti, in the funnel cavity,
   4. An outlet pipe coupled to the funnel shaped bottom wall of the furnace for providing the melted titanium, Ti, through the outlet pipe.

In another embodiment, the invention teaches a microwave gun and arc plasma torch furnace for generating melted Ti from TiO₂ powder, the furnace comprising:
a. a hollow outer shell configured with a cavity to contain gasses therein,
b. an inlet pipe coupled to a first end of the hollow outer shell for allowing access to the cavity for providing the titanium dioxide powder, TiO₂, into the cavity,
c. A plurality of microwave emitters coupled to the hollow outer shell, the plurality of microwave emitters for directing high frequency microwave radiation into the cavity to produce a high temperature zone for lengthening and weakening the valence bonds between the titanium atom, Ti, and the oxygen atoms, O, in the titanium dioxide, TiO₂, wherein the location of the plurality of microwave emitters are predetermined to facilitate rotation and even heating of the TiO₂ powder,
d. a plurality of arc plasma torch generators coupled to the hollow outer shell, wherein the plurality of arc plasma torch generators generate a nitrogen, N⁺ jet, plasma torch into the cavity, and wherein the arc plasma torch generator directs the N⁺ jet torch for disassociating the titanium atom, Ti, and the oxygen atoms, O, in TiO₂ molecules to produce nitrogen dioxide, NO₂, and melted titanium, Ti.

### BRIEF DESCRIPTION OF DRAWINGS

The accompanying drawings, which are incorporated in and constitute a part of this specification, illustrate exemplary and preferred embodiments of the invention, and together with the description, serve to explain the principles of the apparatus taught, herein.

FIG. 1 depicts an exemplary a microwave gun and arc plasma torch furnace according to the present invention.

FIG. 2 is an exemplary cross section of the cylindrical upper portion of a microwave gun and arc plasma torch furnace according to exemplary embodiments of the present invention

FIG. 3 is an exemplary cross section of the funnel shaped lower portion of a microwave gun and arc plasma torch furnace according to exemplary embodiments of the present invention

FIG. 4 depicts exemplary operation of the exemplary microwave gun and arch arc plasma torch furnace according to the present invention.

FIG. 5 depicts an exemplary method that may be practice using the exemplary microwave gun and arch arc plasma torch furnace according to the present invention.

### DETAILED DESCRIPTION OF THE PREFERRED EMBODIMENT

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper”, “front”, “rear”, “back”, “bottom” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 9° C. or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein, but are to include deviations in shapes that result, for example, from manufacturing.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It also will be understood that when an element is referred to as being “on”, “in communication with”, or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

It should also be understood that the present description makes reference to concepts that are well known to those skilled in the art. Therefore, the concepts will not be discussed for the sake of brevity. For example, the construction and operation of microwave emitters (e.g., microwave guns) and guides, air pumps, and arch arc plasma torches, and the related equipment to ensure the operation of microwave guns are not included herein, as they are understood by one skilled in the art. Similarly, the present invention includes conventional arc plasma torches. The operation of arc plasma torches, and the related equipment to ensure the operation of arc plasma torches, are not included herein, as they are understood by one skilled in the art. In both instances, although not discussed in detail because one skilled in the art is familiar with their operation, it should be understood that the equipment necessary to for the operation of microwave guns and arc plasma torches are included herein.

Similarly, valence bonds between atoms, disassociation of atoms, the vibrating of atoms in molecules caused by microwaves, and combining of atoms are concepts understood by one skilled in the art. As such, these concepts will also not be discussed herein for brevity.

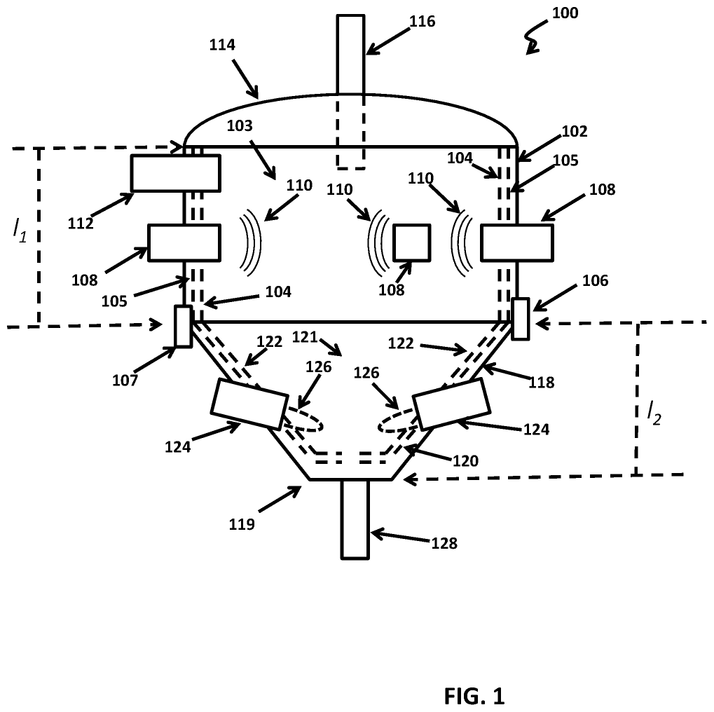

FIG. 1 depicts an exemplary embodiment of the microwave gun and arc plasma torch furnace 100 according to exemplary embodiments of the present invention. As shown, furnace 100 may include a hollow shell having a cylindrical shaped upper portion 102, coupled to a funnel shaped lower portion 118. In a preferred embodiment cylindrical shaped upper portion 102 may be a cylindrical shell (e.g., a right circular hollow cylinder). In one exemplary embodiment cylindrical shaped upper portion 102 may be coupled to funnel shaped lower portion 118 using, for example, a hinge 106 and latch 107 arrangement, wherein hinge 106 and latch 107 are any conventional hinge and latch.

In operation, hinge 106 may permit cylindrical shaped upper portion 102 to pivot at the hinge 106 location. When the cylindrical shaped upper portion 102 is positioned above 106 may the funnel shaped lower portion 118, latch 107 may hold cylindrical shaped upper portion 102 in a fixed position relative to funnel shaped lower portion 118. In another exemplary embodiment, latch 107 may hold may hold cylindrical shaped upper portion 102 in a removably fixed position relative to funnel shaped lower portion 118.

Cylindrical shaped upper portion 102 may further include a cavity 103 therein. Cavity 103 may be parallel to the cylindrical shaped upper portion 102 central axis. Cylindrical shaped upper portion cavity 103 may be configured to ensure that cylindrical shaped upper portion 102 is hollow, such as in a cylindrical shell. In this way, a first end of cylindrical shaped upper portion is open, and a second end of cylindrical shaped upper portion is also open.

Cylindrical shaped upper portion cavity 103 may be formed by a cylindrical shaped upper portion outer wall 105. Cylindrical shaped upper portion cavity 103 may be located throughout the length of cylindrical shaped upper portion 102, such that the cavity 103 may be accessed from both ends of cylindrical shaped upper portion 102.

Furnace 100 may include a top cover 114 coupled to a first end of cylindrical shaped upper portion 102. Top cover 114 may be configured to cover the first end of cylindrical shaped upper portion 102. Top cover 114 may be configured for covering the cylindrical shaped upper portion cavity 103. In one exemplary embodiment, top cover 114 may be concave. For example, the dimensions of the concave portion of top cover 114 may be such that the radius of the concave may be that portion of the sphere with radius of 3000 mm, wherein the arc of the concave portion spans a 9.6° angle.

Top cover 114 may seal the cylindrical shaped upper portion cavity 103 against gas from entering or exiting the cylindrical shaped upper portion cavity 103. Top cover 114 may be constructed of similar or the same material as is used to construct cylindrical shaped upper portion 102. Namely, top cover 114 may be comprised of metal cable of withstanding the temperatures noted in the reactions herein. For example, top cover 114 may be constructed of steel. More particularly, top cover 114 may be comprised of 8 mm steel plate.

The inner surface of top cover 114, the surface of top cover 114 closest to the cylindrical shaped upper portion cavity 103, may be coated with a refractory paste. In one exemplary embodiment, the refractory paste may a conventional refractory paste capable of withstanding 1500° C. Further still, top cover 114 may include an inlet pipe 116 for allowing entrance into cylindrical shaped upper portion 102. In one exemplary embodiment, inlet pipe 116 may include a 120 mm outer diameter, an inner diameter of 110 mm, and a 5 mm wall thickness. The length of the inlet pipe may be 500 mm. In another particular embodiment, inlet pipe 116 may be connected to top cover 114 using a flange. In still another particular embodiment, inlet pipe 116 may be constructed of stainless steel.

It should be noted, that although the invention is described as upper and lower, the invention may also have alternate configurations. In some cases, such alternate configurations may better facilitate maintenance or cleaning of furnace 100. For example, the invention may be described as having left portion and a right portion. In such an embodiment, furnace 100 may retain the overall shape. Namely, the overall shape of the furnace 100 may include a cylindrical shaped upper portion 102 in communication with a funnel shaped lower portion 118.

In one exemplary embodiment, the length, l1, of cylindrical shaped upper portion 102 may be equal to the length, l2, of funnel shaped lower portion 118. For example, cylindrical shaped upper portion 102 may have a length, l1, of 1,000 mm, and funnel shaped lower portion may have a length, l2, of 1,000 mm. In another exemplary embodiment, the length, l1, of cylindrical shaped upper portion 102 may substantially equal to the length, l2, of funnel shaped lower portion 118. By substantially equal, what may be meant is that the length, l1, may be within 25% of the length, l2. For example, in a particular embodiment, cylindrical shaped upper portion 102 may have a length, l1, of 1,000 mm, and the funnel shaped lower portion 118 may be 892 mm in length, l2.

The cylindrical shaped upper portion 102 may be hollow. As noted, the cylindrical shaped upper portion 102 may include an internal cavity 103. More particularly, cylindrical shaped upper portion 102 may include an outer wall 105 having a thickness. Outer wall 105 of the cylindrical upper portion 102 may include a 1000 mm diameter. Cylindrical shaped upper portion 102 may be constructed of metal able to withstand the high temperatures discussed herein. The metal used to construct the cylindrical shaped upper portion 102 may be able to withstand at least 1,500° C. In another exemplary embodiment cylindrical shaped upper portion 102 may be comprised of steel. For example, cylindrical shaped upper portion 102 may be constructed of 8 mm steel plate. In still another exemplary embodiment, the inner surface of cylindrical shaped upper portion outer wall 105 may be cylindrical in shape. The inner surface of cylindrical shaped upper portion may include an inner diameter.

In yet another exemplary embodiment, the inner surface of cylindrical shaped upper portion outer wall 105 may be coated or covered with refractory paste 111. In one exemplary embodiment, the inner surface of the cylindrical shaped upper portion outer wall 105 may be coated with 100 mm layer of refractory paste 111. In another exemplary embodiment, the refractory paste 111 may sustain at least 1500° C. temperature.

Cylindrical shaped upper portion 102 may include a gas pump 112 for removing gas from inside cylindrical shaped upper portion cavity 103, as more fully below. Gas pump 112 may be coupled to cylindrical shaped upper portion 102. Gas pump 112 may be further coupled to the cylindrical shaped upper portion outer wall 105, using any conventional coupling means used for coupling gas pumps to metal. For example, gas pump 112 may be coupled to cylindrical shaped upper portion 102 by a flange.

Additionally, although the present invention describes gas pump 112 as being coupled to cylindrical shaped upper portion 102, the gas pump 112 may be coupled to the funnel shaped lower portion 118 in similar manner as is described with respect to cylindrical shaped upper portion 102. An exemplary, pump 112 that may be used with the invention may be, for example, a conventional anti-collision pump.

Cylindrical shaped upper portion 102 may further include one or more microwave emitters 108 for directing microwaves into cylindrical shaped upper portion cavity 103. Microwave emitters may be any conventional microwave emitter capable of emitting 0.3 GHz to 300 GHz frequency. Microwave emitters 108 may be coupled to cylindrical shaped upper portion 102 using any conventional connection or coupling means. In an exemplary embodiment, microwave emitters 108 may be of the type called or manufactured by for, example Guoli, Ldt, China.

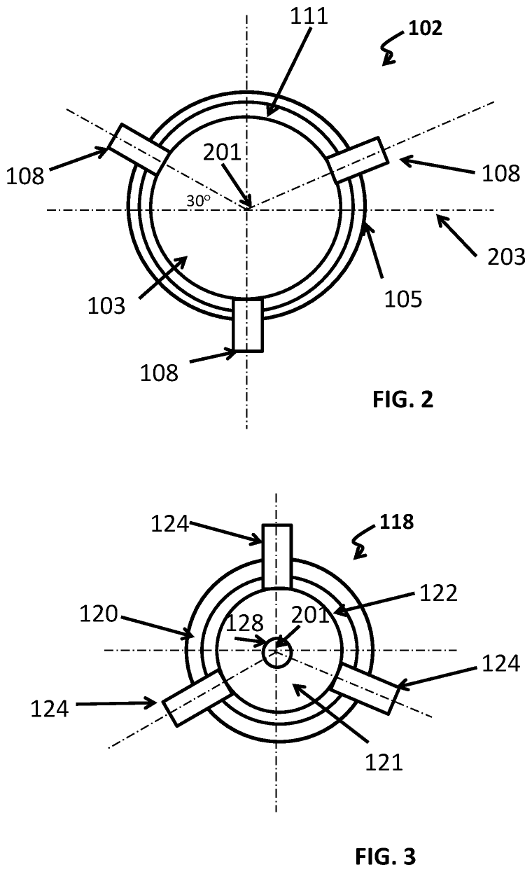

In another exemplary embodiment, microwave emitters 108 may be a 100 KW microwave emitter. In one exemplary embodiment, microwave emitters 108 may be placed 600 mm from the first open end of the cylindrical shaped upper portion 102. With brief reference to FIG. 2, what is shown is cross section of cylindrical shaped upper portion 102. In the cross section shown, an exemplary placement of microwave emitters 108 in reference to the central axis 201 of cylindrical shaped upper portion 102 is also illustrated. In an exemplary embodiment, as is understood by one skilled in the art that the waveguides of microwave emitters direct the microwaves generated. As discussed more fully below, microwave emitters 108 may be positioned such that the waveguides direct the microwaves generated by microwave emitters 108 to cause the rotation of TiO₂ powder entering cylindrical shaped upper portion 102 through inlet pipe 116. Inlet pipe 116 may be connected to top cover 114 using any conventional flange.

In an exemplary embodiment, microwave emitter 108 waveguides direct the microwaves generated at 90° angle relative to the central axis 201 of cylindrical shaped portion 102. In accordance with this invention, microwave emitters 108 direct the microwaves generated toward the cylindrical shaped upper portion inner cavity 103.

As noted, the location of microwave emitters 108 may be predetermined to facilitate the rotation of the titanium dioxide powder, TiO₂, being added to cylindrical shaped upper portion inner cavity 103 via inlet pipe 116. In the exemplary embodiment shown, which uses three microwave emitters 108, the microwave emitters 108 may be set clockwise at angles of 60°, 180° and 300° on the on the same plane in cross section but shifted clockwise by 5 mm from the radius lines at angles of 60°, 180° and 300° on the cross section circle. In another exemplary embodiment shown, which uses three microwave emitters 108, the microwave emitters 108 may be set clockwise at angles of 60° C., 180° C. and 300° C. with reference a single point on a lateral axis to the central axis 201, but shifted clockwise by 5 mm from the radius lines at angles of 60°, 180° and 300° on the cross section circle.

With return reference to FIG. 1, as noted, furnace 100 may include funnel shaped lower portion 118 coupled to cylindrical shaped upper portion 102. It is well known that funnels have a first end that is wider that a second end such that the funnel tapers from the wider first end to the narrower second end. In one exemplary embodiment, a first end of funnel shaped lower portion 118 may be coupled to the second end of cylindrical shaped upper portion 102, wherein the second end of cylindrical shaped upper portion 118 is distant from the first end of cylindrical shaped upper portion 118.

Funnel shaped lower portion 118 may include an inner cavity 121, formed by the outer wall 120. Funnel shaped portion inner cavity 121 may be in communication with cylindrical shaped upper portion cavity 103. Outer wall 120 may be constructed of metal able to withstand the reactions occurring in the funnel shaped lower portion inner cavity 121. Outer wall 120 may be comprised of steel. For example, outer wall 120 may be comprised of 8 mm steel plate.

Further still, the inner surface of the outer wall 120 closest to the inner cavity 121 may be coated with a refractory paste 122. In one exemplary embodiment, the inner surface of outer wall 120 may be coated with a refractory paste 122 capable of withstanding at least 1500° C. More particularly, inner surface of outer wall 120 may be coated with 100 mm of refractory past 122 capable of sustaining 1500° C.

In the example shown, the diameter of cylindrical shaped upper portion 102 may be the same as or substantially the same as the diameter of the first end of the funnel shaped lower portion 118 in communication with second end of the cylindrical shaped upper portion 102. For example, the diameter of second end of cylindrical shaped upper portion 102 may be 1000 mm, and the diameter of the first end of the funnel shaped lower portion 118 may also be 1000 mm.

The second end 119 of the funnel shaped lower portion 118 will have a smaller diameter than the first end of funnel shaped lower portion 118. In another exemplary embodiment, cavity 121 is conical in shape, wherein the first end of funnel shaped lower portion 118 is matched to the base of the cone and funnel shaped lower portion second end 119 is matched to the vertex of the cone. This configuration allows liquid (e.g., melted titanium, Ti, as described below) to be conducted from the first end of funnel shaped lower portion 118 to funnel shaped lower portion second end 119. In one particular example, the diameter of first end of funnel shaped lower portion may be 1000 mm and the diameter of the funnel shaped lower portion second end 119 (e.g., the narrow end of the funnel shaped lower portion 118) may be 500 mm.

Second end 119 of the funnel shaped lower portion 118 may further include an outlet pipe 128. Outlet pipe 128 may be constructed to provide access to funnel shaped lower portion cavity 121 from outside funnel 100. The outlet pipe 128 may be constructed to permit the flow of melted titanium, Ti, out of funnel shaped lower portion 118, as described more fully below. In one exemplary embodiment, outlet pipe 128 may be comprised of ceramic. Outlet pipe 128 may have an inner diameter 100 mm and an outer diameter of 120 mm diameter and a length of 400 mm. The outlet pipe may be connected to the funnel shaped lower portion second end 119 using for example, a conventional flange.

With reference to FIG. 1, and the cross section of funnel shaped lower portion 118 shown in FIG. 3, funnel shaped lower portion 118 may further include one or more arc plasma torch generators 124. In a preferred embodiment, arc plasma torch generators 124 may use nitrogen gas as the arc plasma media. More particularly, arc plasma torch generators 124 may produce N⁺, using nitrogen gas as its arc plasma media.

It is well known that arc plasma torch generators use torch tubes to direct the arc plasma generated. Arc plasma torch generators 124 torch tubes may direct the generated plasma torch toward the funnel shaped lower portion cavity 121. The arch plasma torch generators 124 of the present invention may be placed 400 mm from the second open end of the funnel shaped lower portion.

In another particular embodiment of the invention, the center line of the torch tubes of the arc plasma torch generators 124 may point at a 30° angle below the horizontal, and toward the outlet pipe 128. In still another exemplary embodiment, the center line of the torch tubes of the arc plasma torch generators 124 may point at a 30° angle below the horizontal, and toward the outlet pipe 128, and at least 5 mm shifted clockwise from the radius lines at the angles 0°, 120° and 240° along the cross section circle. In still a further exemplary embodiment, the center line of the torch tubes of the arc plasma torch generators 124 may point at a 30° angle below the horizontal, and toward the outlet pipe 128, and at least 5 mm shifted clockwise from the radius lines at the angles of 120° and 240° along a lateral cross section and relative to a single point on the lateral cross section. In still another embodiment, arc plasma torch generators 124 may be directed at least 30° below a lateral axis of furnace 100. Even more particularly, arc plasma torch generators 124 may be directed at least 30° below any lateral axis of funnel shaped lower portion 118.

In one particular embodiment, the arc plasma torch generators 124 are coupled to funnel shaped lower portion 118 using any conventional means for connecting arc plasma torch generators to a steel cavity. For example, arc plasma torch generators 124 may be connected using a flange. In another exemplary embodiment, arc plasma torches generators 124 may be further coupled to the funnel shaped lower portion 118 inner surface using a refractory paste 122 of similar description as was described above. In still another exemplary embodiment, arc plasma torch generators 124 may be coupled to inner surface of funnel shaped lower portion outer wall 120 using refractory paste 122.

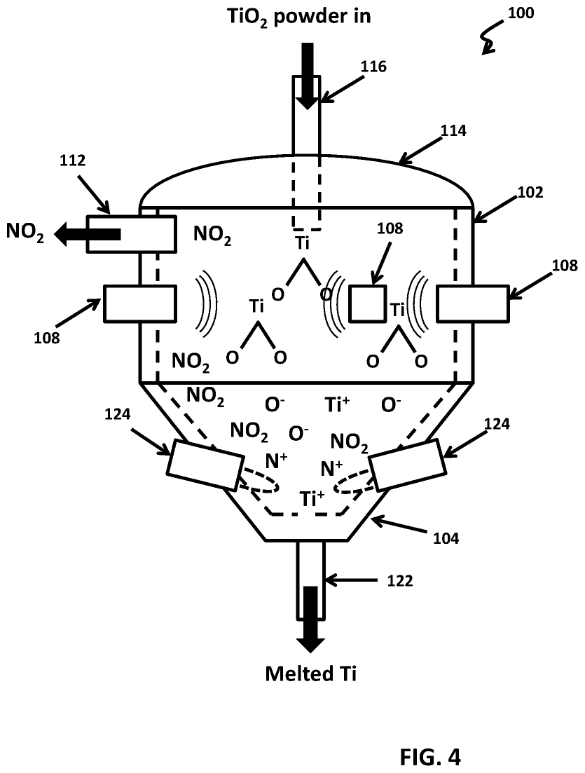

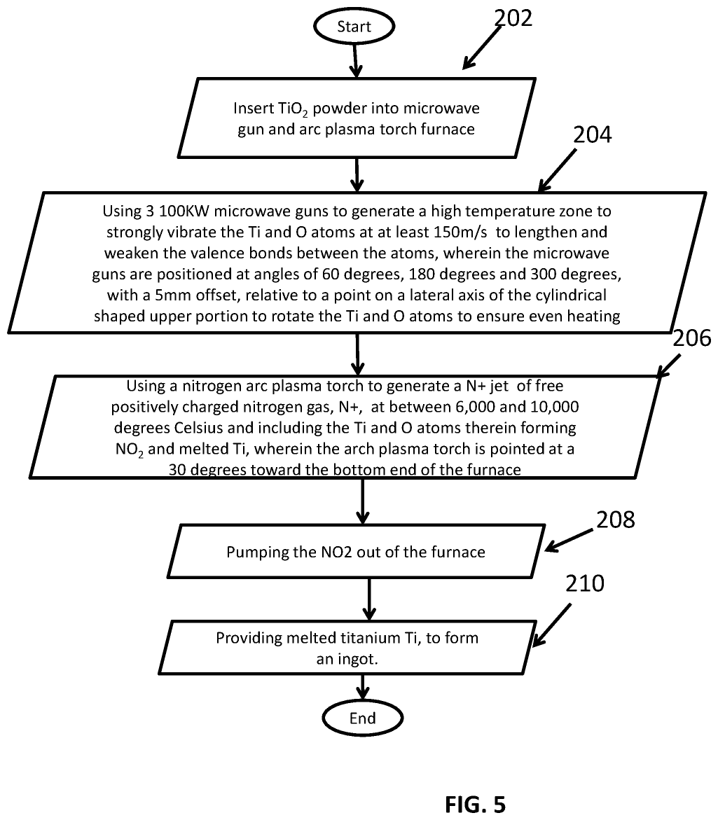

The operation of furnace 100 may be understood with reference with FIG. 4 and FIG. 5. Particularly, the present invention discloses a furnace 100 for refining titanium, Ti, from TiO₂ powder. A user may provide titanium dioxide powder, TiO₂, into furnace inlet tube 116 (Step 202), such that the TiO₂ powder enters the at least 1200° C. high temperature zone generated by the 100 KW microwave emitters 108, wherein the microwave emitters 108 generate at least 0.3 GHz to 300 GHz frequency (Step 204).

The high temperature zone lengthens and weakens the valence bonds between the titanium atoms and oxygen atoms in the TiO₂ molecule. It is well known that the disassociation energy of titanium dioxide, TiO₂, molecule is 1.05×10⁻¹⁸ J. The chemical formula governing the disassociation of the titanium dioxide, TiO₂, molecule is given by equation (1).

TiO₂+1.05×10⁻¹⁸ J=Ti⁺+2O⁻ (1)

By heating the TiO₂ molecule in the high temperature zone, the high frequency microwaves will strongly vibrate the titanium, Ti, and oxygen, O, atoms. If the vibration kinetic energy is greater than the disassociation energy, the bond between the titanium, Ti, and oxygen, O, atoms will be broken. The kinetic vibration energy, K, necessary to disassociate the Ti and O atoms is given by equation (2),

K=(½)mv²=1.05×10⁻¹⁸ J, (2)

Wherein m=79.847×10⁻²⁷ kg represents the atomic mass of Ti. Using equation (2), it can be seen that the titanium, Ti, and oxygen, O, atoms must vibrate at 514 m/s to completely disassociate.

Particularly, to estimate the heat necessary to completely disassociate the valence bonds between the titanium, Ti, and oxygen, O atoms in the TiO₂ molecule, may be estimated by solving equation (3),

$$\frac{1}{2} m {v}^{2} \approx \frac{3}{2} k T , k = 1.38 \times {10}^{- 23} \frac{J}{K} . \qquad ( 3 )$$

That is, the heat generated to disassociate the atoms in the titanium dioxide molecule, TiO₂, is approximately 6,000-10,000° C. More particularly, when the TiO₂ molecule is subjected to 10000° C. heat, the titanium atom and the oxygen atoms will violently vibrate at 514 m/s, thereby separating the atoms (e.g., completely disassociating them).

However, because microwave emitters 108 produce a 1,200° C. high temperature zone, the temperature in high temperature zone is a lower temperature than is required to completely disassociate the atoms in the TiO₂ molecule. Instead, the high temperature zone generated by the microwave emitters 108 strongly vibrates the titanium, Ti, and oxygen, O, atoms in TiO₂ powder to lengthen and weaken the valence bonds between them (producing Ti—O powder-omit). In one exemplary embodiment, the high temperature zone vibrates the titanium, Ti, and oxygen, O, atoms at about 150 m/s. Further still, as noted, the placement of the microwave emitters 108 inside the cylindrical shaped upper portion cavity 103 are predetermined such that the Ti—O powder in the high temperature zone is rotated and evenly heated. That is, the rotation of the titanium dioxide powder, TiO₂, powder allows for the all the powder to be evenly heated before the powder is further heated by the nitrogen arc plasma torch 124 (step 206).

It is well known that the nitrogen arc plasma torch generating a N⁺ jet uses nitrogen gas, N₂, electrical arc plastron to produce N⁺ and an free electron, e⁻. That is, the nitrogen arc plasma torch disassociates the nitrogen atoms in the nitrogen gas, N₂. It is also well known that the disassociation energy of nitrogen gas, N₂, is 2.32×10⁻¹⁸ J. Consequently, the nitrogen arch plasma torch produces enough energy to disassociate nitrogen gas, N₂.

Further still, the nitrogen arc plasma torch produces heat at between 6,000 and 10,000° C. at the plasma center region. The temperature produced is higher than is required to completely disassociate the titanium, Ti, and oxygen, O, in the TiO₂ molecules. In accordance with the invention, the rotated and evenly heated, strongly vibrating titanium powder, TiO₂, is provided to the nitrogen arc plasma torch N⁺ jet such that the titanium, Ti, and oxygen, O, atoms completely disassociated into titanium ions Ti⁺ and oxygen ions O⁻. The TiO₂ molecules disassociates into oxygen ions, O⁻, and the titanium ions, Ti⁺, and a free electron, e⁻. The free N⁺ ions are then able to combine with the oxygen ions, O⁻, to produce nitrogen dioxide gas, NO₂. The nitrogen dioxide gas may then be removed from furnace 100 using gas pump 112. (Step 208). The titanium ions, Ti⁺, may then combine with the free electron, e⁻, to form melted Ti atoms remaining in funnel shaped lower portion cavity 121. Because the atomic mass of the titanium (atomic mass=47.87 u) is greater than that of oxygen (atomic mass=16), and nitrogen (atomic mass=14) the melted titanium, Ti, may then be deposited at the second end 119 of funnel shaped lower portion 119. The melted titanium, Ti, may be deposited within proximity of outlet pipe 128.

More particularly, positively charged titanium ions, Ti⁺, will sink to the bottom and combine with one free electron, e⁻, to form titanium metal, Ti. In accordance with the invention, the melted titanium, Ti, may then be provided from the cavity 121 through outlet pipe 128. (Step 210) That is, the melted titanium, Ti, may be permitted to be provided through outlet pipe 128. The melted titanium, Ti, provided through outlet pile 128 may be then be cooled to form titanium ingots. The titanium ingots formed this way may be further purified, or processed in accordance with any conventional method for purifying or processing titanium ingots. In this way, the invention teaches forming titanium ingots directly from TiO₂ powder using a single piece of equipment, and fewer steps than is used in conventional refining methods.

It should be noted that although the present invention is described with respect to ordered steps, it should be understood that refining process described herein may be a continuous process. The present invention may begin to make melted titanium, Ti, as soon as the titanium dioxide powder is provided to inlet pipe 116. For example, steps 206 through step 210 may happen simultaneously.

Further it should be noted that the overall configuration for the furnace may change. One skilled in the art will recognize that alternate variations from the cylindrical and funnel shapes will accomplish the objectives described herein. Additionally, one skilled in the art will understand that the present invention may also be practiced with a furnace having a hollow outer shell. In such case, the furnace may include one inner cavity in which the refining reactions take place. The furnace having the hollow outer shell may use microwave emitters, and arc plasma torches as is described with the exemplary embodiment described herein. As such, other shapes of the furnace shell that accomplishing the objectives of this invention may be contemplated herein.

1. A microwave gun and arc plasma torch furnace for generating melted titanium, Ti, from titanium dioxide powder, TiO₂ powder, having an outer shell, the furnace comprising:
a. a cylindrical shaped upper portion including,
1. a cylindrical shaped upper portion outer wall,
2. a cylindrical shaped upper portion inner cavity formed by the inner surface of the cylindrical shaped upper portion outer wall, wherein the cylindrical shaped upper portion inner cavity is parallel to the central axis of cylindrical shaped upper portion, and wherein the cylindrical shaped upper portion inner cavity facilitates a cylindrical shaped upper portion first open end and a cylindrical shaped upper portion second open end,
wherein the cylindrical shaped upper portion first open end is located on a the distal end of the cylindrical shaped upper portion from the cylindrical shaped upper portion second end,
3. a top cover in coupled to with the cylindrical shaped upper portion first open end,
4. an inlet pipe coupled to the top cover for providing access to the cylindrical shaped upper portion inner cavity, wherein the inlet pipe facilitates titanium dioxide powder to be poured into the cylindrical shaped upper portion inner cavity,
5. a plurality of microwave emitters coupled to the cylindrical shaped upper portion outer wall for directing high frequency microwave radiation into the cylindrical shaped upper portion inner cavity to produce a high temperature zone for lengthening and weakening the valence bonds between the titanium atom, Ti, and the oxygen atoms, O, in the titanium dioxide powder, TiO₂, wherein the location of the plurality of microwave emitters are predetermined to facilitate rotation and even heating of the titanium dioxide powder, TiO₂, and wherein the cylindrical shaped upper portion inner cavity is configured to provide the rotated and evenly heated titanium dioxide powder, TiO₂ powder to the cylindrical shaped upper portion second open end, and
b. a funnel shaped lower portion having a first open end coupled to the cylindrical shaped upper portion second open end, the funnel shaped lower portion further including,
1. a funnel shaped lower portion outer wall,
2. a funnel shaped lower portion inner cavity formed within the funnel shaped lower portion outer wall for receiving the titanium dioxide powder, TiO₂, wherein the inner cavity facilitates a funnel shaped lower portion first open end and a funnel shaped lower portion second open end, wherein the funnel shaped lower portion inner cavity is conical in shape, wherein the funnel shaped lower portion outer wall includes an inner surface configured to facilitate a liquid being transported from the funnel shaped lower portion first open end to funnel shaped lower portion second open end, wherein the second open end of the cylindrical shaped upper portion is in communication with the first open end of the funnel shaped lower portion, wherein the cylindrical shaped upper portion inner cavity and the funnel shaped lower portion inner cavity form funnel cavity,
3. an arc plasma torch generator coupled to the funnel shaped lower portion outer wall, wherein the arc plasma torch generator generates nitrogen, N⁺ jet, torch into the funnel shaped lower portion inner cavity, and wherein the arc plasma torch generator directs the N⁺ jet torch toward funnel shaped portion second open end, wherein the arch plasma torch disassociates the titanium atom, Ti, and the oxygen atoms, O, in the rotated and heated titanium dioxide powder, TiO₂, to produce nitrogen dioxide, NO₂, and melted titanium, Ti, in the funnel shaped lower portion inner cavity,
4. an outlet pipe formed in a funnel shaped lower portion for providing the melted titanium, Ti, through the outlet pipe.

2. A microwave gun and arc plasma torch furnace according to claim 1 further comprising, a refractory paste coated on the cylindrical shaped top portion outer wall inner surface and the funnel shaped lower portion outer wall inner surface.

3. A microwave gun and arc plasma torch furnace according to claim 2 further comprising, a gas pump coupled to the furnace outer shell, wherein the gas pump is configured to pump gas from the furnace cavity.

4. A microwave gun and arc plasma torch furnace according to claim 3, wherein the refractory paste can withstand temperatures greater than 1,500° C.

5. A microwave gun and arc plasma torch furnace according to claim 4, wherein the plurality of microwave emitters are 100 kw microwave emitters.

6. A microwave gun and arc plasma torch furnace according to claim 5, wherein the plurality of microwave emitters produce a microwave frequency from 0.3 GHz to 300 GHz.

7. A microwave gun and arc plasma torch according to claim 6, wherein the number of plurality of microwave emitters is three, and wherein each of the plurality of microwave emitters emit microwaves at 90 degrees relative to the cylindrical shaped upper portion central axis, wherein the first of the plurality of microwave emitters is position at 60 degree angle the second of the plurality of microwave emitters is positioned at 180 degree angle, and the third of the plurality of microwave emitters is positioned at 300 degree angle, and shifted 5 mm clockwise relative to a single point on a lateral edge of the cylindrical shaped outer portion inner surface for rotating and evenly heating the titanium dioxide powder, TiO₂, and wherein each of the plurality of microwave emitters emit microwaves on the same lateral plane.

8. A microwave gun and arc plasma torch furnace according to claim 7, wherein the plurality of microwave emitters are coupled 600 mm from the first open end of the cylindrical shaped upper portion.

9. A microwave gun and arc plasma torch furnace according to claim 8, wherein the arc plasma torch is coupled to the funnel shaped lower portion inner wall using the refractory paste, and wherein the arc plasma torch directs the plasma generated at 30 degrees below a lateral axis of the funnel shaped lower portion.

10. A microwave gun and arc plasma torch furnace according to claim 9, further including multiple arc plasma torches, wherein the multiple plasma torches are coupled to the funnel shaped lower portion outer wall, where the multiple arc plasma torches are coupled 600 mm from the first open end of the cylindrical shaped upper portion, wherein the arc plasma torches generate a N+ Jet plasma, wherein the multiple arc plasma torches at direct the plasma generated by the multiple plasma arc torches at a 30 degree angle below a lateral axis of the funnel shaped lower portion.

11. A microwave and arc plasma torch furnace according to claim 9, wherein the high temperature zone generated by the plurality of microwave emitters is 1,200° C.

12. A microwave and arch plasma torch furnace according to claim 9, wherein the N⁺ jet torch generates heat between 6,000-10,000° C. at the center of the torch.

13. A microwave gun and arc plasma torch furnace for generating melted titanium, Ti, from titanium dioxide powder, TiO₂, the furnace comprising:
a. a hollow outer shell configured with a cavity to contain gasses therein,
b. an inlet pipe coupled to a first end of the hollow outer shell for allowing access to the cavity for pouring titanium dioxide powder, TiO₂, inside the cavity,
c. a plurality of microwave emitters coupled to the hollow outer shell, the plurality of microwave emitters for directing high frequency microwave radiation into the cavity to produce a high temperature zone for lengthening and weakening the valence bonds between the titanium atom, Ti, and the oxygen atoms, O, in the titanium dioxide, TiO₂, wherein the location of the plurality of microwave emitters are predetermined to facilitate rotation and even heating of the titanium dioxide powder, TiO₂,
d. an outlet pipe coupled to a second end of the hollow outer shell for providing access to the cavity, wherein the first end of the hollow outer shell is distal from the second end of the hollow outer shell,
e. a plurality of arc plasma torch generators coupled to the hollow outer shell, wherein the plurality of arc plasma torch generators generate a nitrogen, N⁺ jet, plasma torch into the cavity, and wherein the plurality of arc plasma torch generators direct the nitrogen, N⁺ jet, plasma torch toward the outlet pipe, wherein the plurality of arc plasma torch generators disassociates the titanium atom, Ti, and the oxygen atoms, O, in the titanium powder, TiO₂, to produce nitrogen dioxide, NO₂, and melted titanium, Ti.

14. A microwave gun and arc plasma torch furnace according to claim 13 further comprising, a refractory paste coated on the inner wall of the hollow outer shell.

15. A microwave gun and arc plasma torch furnace according to claim 14, wherein the refractory paste sustains temperature greater than 1,500° C.

16. A microwave gun and arc plasma torch furnace according to claim 15, further comprising, a gas pump coupled to the hollow outer shell, wherein the gas pump is configured to pump nitrogen dioxide, NO₂, gas from the cavity.

17. A microwave gun and arc plasma torch furnace according to claim 16, wherein the plurality of microwave emitters are 100 kw microwave emitters, wherein the plurality of microwave emitters produce a frequency of from 0.3 GHz to 300 GHz, and wherein the high temperature zone is at least 1,200° C.

18. A microwave gun and arc plasma torch according to claim 17, wherein the number of plurality of microwave emitters is three, wherein each of the plurality of microwave emitters is coupled to the hollow outer shell at 600 mm from the hollow shell first end, wherein each of the plurality of microwave emitters emit microwaves into the cavity at 90 degrees angle relative to the cylindrical shaped upper portion central axis, wherein the first of the plurality of microwave emitters is position at a 60 degree angle, the second of the plurality of microwave emitters is positioned at a 180 degree angle and the third of the plurality of microwave emitters is positioned at a 300 degree angle relative to a single point on a lateral edge of the cylindrical shaped outer portion inner surface for rotating and evenly heating the titanium dioxide powder, TiO₂, and wherein each of the plurality of microwave emitters emit microwaves on the same lateral plane.

19. A microwave gun and arc plasma torch according to claim 18, wherein the plurality of arc plasma torches are coupled to the hollow shell outer wall using the refractory paste, and wherein the plurality of arc plasma torches direct the plasma generated at a 30 degree angle below a lateral axis of the hollow outer shell, and wherein the plurality of arc plasma torch generators are coupled to the hollow outer shell at least 400 mm from the hollow outer shell second end.

20. A microwave and arc plasma torch furnace according to claim 19, wherein the high temperature zone generated by the plurality of microwave emitters is 1,200° C.
